(19) United States
(12) Patent Application Publication
(10) Pub. No.: US 2003/0126197 A1
(43) Pub. Date: Jul. 3, 2003

(54) Efficient content placement using network proximity

(76) Inventors: Brad R. Black, Carp (CA); Garnet C. Ulrich, Kanata (CA); Peter T. Ashton, Nepean (CA)

Correspondence Address: Robert A. Wilkes, P.O. Box 3440, Station D, Ottawa, ON, K1P 6P1, CA

(21) Appl. No.: 10/028,795

(22) Filed: Dec. 28, 2001

(51) Int. Cl. G06F 15/173; G06F 15/16

(52) U.S. Cl. 709/203; 709/225

(57) ABSTRACT

A data management system for duplicating specific data initially located at a main server in at least one other server within a common data network. When a user requests the specific data from the main server, the main server instructs the end user to request the specific data from a particular server that not only contains a copy of the specific data but also fulfills a certain set of criteria. Such criteria may be based on the physical distance between a particular server and the end user, or the number of hubs in a preferred path between a particular server and the end user. The present invention is useful for placing data, such as multimedia content, that is streamed from a source to a destination. When positioning multimedia content, the physical proximity of the source to the destination is an important factor. The main server will select a first multimedia server to receive a copy of the multimedia content based on the physical proximity of the first multimedia server to each end user requesting the multimedia content.

### FIELD OF THE INVENTION

The present invention relates to the placement of data content in a data network. More particularly, the present invention relates to the placement of multimedia content originating from a main server to a multimedia sever located more proximate to end users requesting the multimedia content.

### BACKGROUND OF THE INVENTION

In the field of data networks, data communication between various nodes in a data network not only includes the exchange of e-mails or other forms of data but also video streaming or video conferencing in real-time. Data congestion, resulting from insufficient data handling resources at specific nodes, is an increasingly important issue with regard to data traffic over the Internet. Problems related to data congestion have further arisen with the increasing demand for data that is multimedia content, such as video and music files, or any other content that contains a large amount of data. These types of data content currently being delivered cause a high volume of data to be transmitted through a given node. For a given amount of time, the volume of data that a data router is required to receive and to buffer can be greater than the volume of data the data router can transmit. This imbalance between the volume of data received and the volume of data transmitted results in congestion at the given node. The physical link between a transmitting node and a receiving node may also have a high volume of data traffic flowing through the physical link which may cause further congestion.

Streaming multimedia content, for example, inherently requires that the end user receive the multimedia content in real-time. In addition, the multimedia content must also be streamed such that the quality or the resolution of multimedia files is not compromised by a data loss through transmission. Thus, a content source that is transmitting the multimedia content to the end user must transmit high volumes of data per unit of time in order to stream the multimedia content without delay or data loss.

Furthermore, data transmission problems related to streaming any type of data content increase as either the physical or the logical distance between the content source and the end user increases. For clarity, the logical distance can be defined as being the number of hubs or “hops” that the data has to traverse between the source and the destination. One explanation for the above delays is that, as either physical or logical distance increases, more hops through network hubs have to be taken by a data unit or a data stream. A large number of hops renders the data stream vulnerable to the problems associated with each of the hubs that the stream has to travel through.

Streaming or delivery of specific data can be facilitated by the retrieval of that specific data from a specialized storage and delivery server in a data network whose only task is to store data. For example, an end user wishing to access streaming multimedia data clicks on a link to a source server. This source server normally has the multimedia data. The source server then uploads to the end user a static, premade index file which defines the streaming media file to be downloaded as requested by the end user. The end user (usually automatically) launches an application program (such as RealPlayer™ or Microsoft™ Media Player™) which can handle the streaming media file. The streaming media file is then streamed from the source server to the end user.

One common industry implementation utilizes a multimedia cache server that is part of a user's internet service provider (ISP) network. The ISP has to purchase a multimedia cache server through which a user's traffic passes. If an end user connected to the ISP requests a specific multimedia file from a remote server, the multimedia cache server intercepts that request. If the multimedia cache server has the specific file being requested, then a premade static index file pointing to the local multimedia cache server and the specific multimedia file is sent to the requesting end user. The end user then receives the streaming data from his ISP's multimedia server. However, if the end user's ISP does not have such a server, the request and the requested file travel the normal route through the Internet.

The above solution has a number of drawbacks. First, to take advantage of the solution, an end user's ISP has to purchase multimedia cache server, which may be costly. Second, the end user's ISP, if it has an multimedia cache server, that server must contain the requested file. Thus, this solution requires that the ISP maintain large amounts of data storage in order to provide only a fraction of the multimedia files sought by each end user.

One other solution provides that a series of data servers maintain a duplicate of the data content stored in a main server. Unfortunately, this solution is costly as it requires all data servers to maintain large amounts of data storage.

In order to overcome the above shortcomings of the prior art the present invention seeks to provide a system for placement of specific data content at various data servers such that specific data content is more readily available to an end user requesting the data content. The placement of specific data is based on predetermined criteria such as either the physical or the logical distance between the end user and various data servers.

### SUMMARY OF THE INVENTION

The present invention seeks to provide a data management system for duplicating specific data initially located at a main server in at least one other server within a common data network. When a user requests the specific data from the main server, the main server instructs the end user to request the specific data from a particular server that not only contains a copy of the specific data but also fulfills a certain set of criteria. Such criteria may be based on the physical distance between a particular server and the end user, or the number of hubs in a preferred path between a particular server and the end user. The present invention is useful for placing data, such as multimedia content, that is streamed from a source to a destination. When positioning multimedia content, the physical proximity of the source to the destination is an important factor. The main server will select a first multimedia server to receive a copy of the multimedia content based on the physical proximity of the first multimedia server to each end user requesting the multimedia content.

In a first aspect, the present invention provides a data network management system for positioning data in a data network of nodes, the data network having a plurality of data servers, and the data network having a plurality of end users, the system including:

a main data storage means for storing the data sent to the end users in the data network;

a data positioning means for sending a copy of data stored in the main data storage means to a first data server selected from the plurality of servers based on specific predetermined criteria, the first data server having a location proximate to at least one end user requesting the data from a node; and

a memory means for maintaining a data file containing a current location of the data sent to a first data server.

In a second aspect, the present invention provides a method of positioning data in a data network, the data network having a main server and at least one data server, the data network having a plurality of end users, the method including the steps of:

(a) selecting a first data server from the at least one data server based on specific predetermined criteria;

(b) sending specific data from the main server to a first data server;

(c) receiving at the main server a first request for the specific data, the first request being sent by an end user to the main server;

(d) selecting the first data server as being suitable for providing the specific data requested by the end user; and

(e) sending instructions to the end user to request the specific data from the first data server.

In an alternative second aspect, the present invention provides a method of positioning data in a data network, the data network having a main server and at least one data server, the data network having a plurality of end users, the method including the steps of:

(a) receiving at the main server a request for the specific data, the request being sent by an end user to the main server;

(b) if a request threshold limit has been previously met, sending instructions to the end user to request the specific data from the first data server;

(c) if the request received in step (a) causes the request threshold limit to be met, executing the following steps;

(c1) selecting a first data server from the at least one data server based on specific predetermined criteria;

(c2) sending specific data from the main server to a first data server

(c3) selecting the first data server as being suitable for providing the specific data requested by the end user; and

(c4) sending instructions to the end user to request the specific data from the first data server.

In a third aspect, the present invention provides a method of positioning multimedia data in a data network, the data network having a main server and at least one multimedia server, and the data network having a plurality of end users, the method including the steps of:

(a) identifying each earlier request for specific multimedia data by the plurality of end users and updating a count maintained of each earlier request by the plurality of end users;

(b) selecting a first multimedia server from the at least one multimedia server based on specific predetermined criteria;

(c) sending specific multimedia data from the main server to the first multimedia server, the specific multimedia data identified in at least one earlier request;

(d) receiving at the main server a first request for the specific multimedia data, the first request being sent by a first end user to the main server;

(e) selecting the first multimedia server as being suitable for providing the specific multimedia data requested by the first end user; and

(f) sending instructions to the first end user to request the specific multimedia data from the first data server.

In a fourth aspect, the present invention provides a method of positioning data in a data network, the data network having a main server and at least one multimedia server, the data network having a plurality of end users, the method including the steps of:

(a) selecting a first data server from the at least one data server based on a set of specific predetermined criteria;

(b) sending specific data from the main server to a first data server;

(c) receiving at least one request for specific data from the plurality of end users;

(d) determining a level of demand for the specific data based on a number of requests from the plurality of end users for the specific data;

(e) if the level of demand for the specific data is less than a first predetermined level, removing the specific data from the first multimedia server;

(f) if the level of demand for the specific data is greater than a second predetermined level, executing the steps of:

(f1) selecting a second multimedia server based on at least a subset of specific predetermined criteria; and

(f2) sending a copy of the specific data to the second multimedia server.

In a fifth aspect, the present invention provides a computer system serving as a data network management system for positioning data in a data network of nodes, the data network having a plurality of data servers, and the data network having a plurality of end users, the computer system including:

a main data storage means for storing the data sent to the end users in the data network;

a data positioning means for sending a copy of data stored in the main data storage means to a first data server selected from the plurality of servers based on specific predetermined criteria, the first data server having a location proximate to at least one end user requesting the data from a node; and

a memory means for maintaining a data file containing a current location of the data sent to a first data server.

In a sixth aspect, the present invention provides a machine readable media containing computer readable and computer executable code to be executed by a data network, the data network having at least one data server, the data network having a plurality of end users, the code implementing a method including the steps of:

(a) selecting a first data server from the at least one data server based on specific predetermined criteria;

(b) sending specific data from the main server to a first data server;

(c) receiving at the main server a first request for the specific data, the first request being sent by an end user to the main server;

(d) selecting the first data server as being suitable for providing the specific data requested by the end user; and

(e) sending instructions to the end user to request the specific data from the first data server.

### BRIEF DESCRIPTION OF THE DRAWINGS

The present invention will now be described with reference to the drawings, in which:

FIG. 1 is an illustration of a network in which the present invention may be embodied;

FIG. 2 is a detailed illustration of an example of a network in which the present invention may be embodied;

FIG. 3 is a flowchart detailing a process for positioning data at a suitable server in a data network according to a third embodiment of the present invention;

FIG. 4 is a flowchart detailing a process for positioning and removing data at various servers in a data network according to a fourth embodiment of the present invention;

FIG. 5 is a flowchart detailing a subsidiary process for removing data from a server in a data network according to a fourth embodiment of the present invention; and

FIG. 6 is a flowchart detailing a subsidiary process for further positioning data according to a fourth embodiment of the present invention.

### DETAILED DESCRIPTION

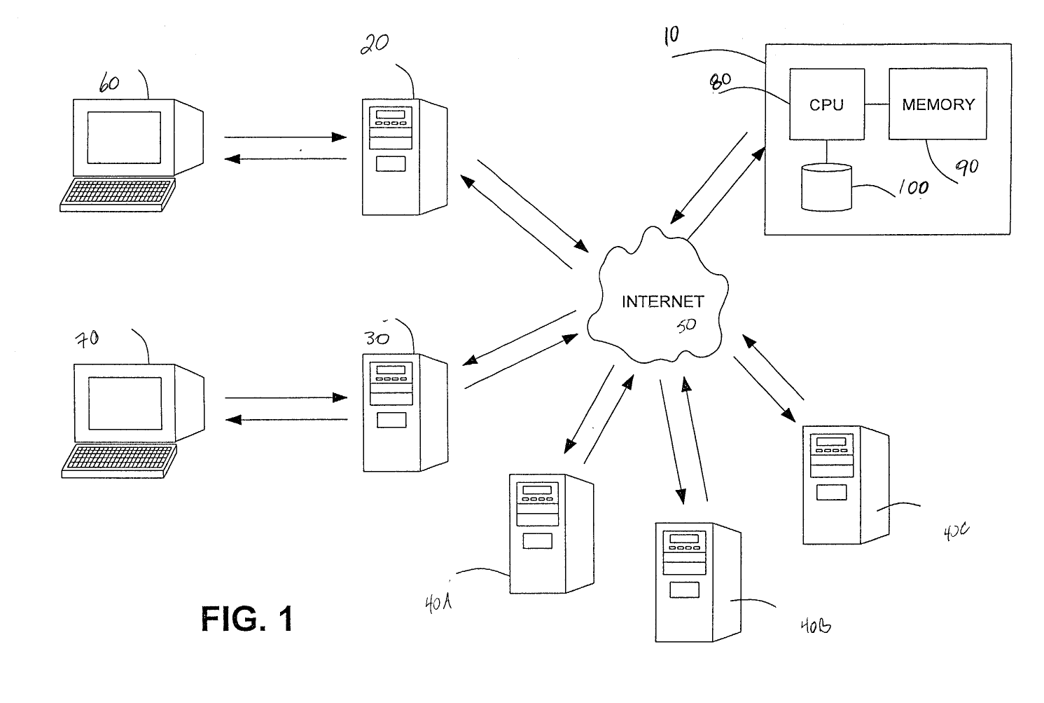

Referring to FIG. 1, a system capable of using the invention is illustrated. A main server 10, two Internet service providers (ISP) network hubs 20, 30, and three multimedia servers 40A, 40B, 40C, are all individually connected to the Internet 50. One of the two ISP hub servers 20 is connected to an end user computer 60, while the other of the two ISP hub servers 30 is connected to an end user computer 70.

For the purposes of this document, a multimedia server is defined as a server which stores and delivers multimedia content. Although a multimedia server may perform other functions and more importantly store other content, it is assumed that a multimedia server is a preferred storage resource for multimedia content.

In FIG. 1, the main server is shown in detail. The main server consists of a central processing unit (CPU) 80 coupled to a memory 90 and to a data storage unit 100 such as a hard disk drive or a RAID (redundant array of inexpensive disks) unit.

It should also be noted that the ISP hub servers 20, 30 represent other networks which connect not only end user computers 60, 70 but other end users to the Internet 50. Such other networks may contain their own multiple hubs, routers, computers, and servers.

For the purposes of this application, the data sent and stored throughout the system will herein be understood to include multimedia content. Although the present invention may provide efficient positioning of various other types of data, the invention will be explained with an emphasis on positioning of multimedia content throughout a global network such as the Internet.

All multimedia content must originate from a particular server. The method of the present invention is implemented at that particular server. Accordingly, the main server 10 is an originating server for multimedia content. All multimedia content located at the main server 10 may be requested at any time. If all end users requested the same multimedia content at one time, congestion would occur at the main server node. In order to avoid congestion, the main server 10 duplicates the multimedia content at various multimedia servers.

In a first embodiment of the present invention, the main server manages the placement of multimedia content throughout a network of multimedia servers. The main server is in direct communication with these multimedia servers. The memory means of the main server maintains a file containing an updated list of the multimedia servers in the network. As the main server receives requests for specific data from end users, the main server maintains a count of the number of requests. Based on this count, the main server selects at least one multimedia server. This multimedia server is selected in order to maximize the efficiency of the transmission of the specific data to the end user. Thus, if a multimedia server is geographically closer to a number of end users requesting the specific data, then this multimedia server will be selected by the main server.

After selecting at least one multimedia server, the main server will then transmit this specific data to the selected multimedia servers. After transmitting the specific data to the multimedia servers, any subsequent request for the specific data received by the main server from an end user who is close to the selected multimedia server will be redirected to these selected multimedia servers. This redirection is accomplished by first determining to which selected multimedia server the request is to be redirected. Once the multimedia server is selected, the main server transmits instructions to the end user that the end user should request the specific data from the selected multimedia server.

In FIG. 1, there are three possible choices from which the main server 10 may choose to position its multimedia content. These three possible choices are multimedia servers 40A, 40B, 40C. As an example, the main server 10 receives requests for particular multimedia content, such as a video clip. The CPU 80 monitors the number of requests received from end users for the video clip x and stores the location of each end user in a table maintained in memory 90. Based on the number of requests received from a particular location or geographical area, the main server 10 will position that video clip at one of the multimedia servers. If the video clip is positioned at the multimedia server 40A the selection could be based on its location being closer to a number of end users requesting the video clip. Upon positioning the multimedia content at the multimedia server 40A, the main server 10 updates the table maintained in memory 90.

It should be mentioned that multimedia content is not removed from the main server 10. Prior to positioning the multimedia content at the local multimedia server 40A, a copy of the multimedia content is retrieved from the data storage unit 100. This copy is then sent to the multimedia server 40A through the Internet 50.

According to a second embodiment of the present invention, the main server, or any server capable of embodying the present invention, monitors the level of demand for specific data being requested by end users in the network. Based on the level of demand the main server may either remove the specific data from a multimedia server where it has been placed or send a duplicate copy to another multimedia server. The level of demand can be determined by counting the number of requests for the specific data in a given amount of time. If the main server determines that level of demand is less than a predetermined level then the multimedia server to which the specific data has been sent previously will be instructed to delete this specific data. Alternatively, the level of demand may be greater than a second predetermined level that indicates an overloading of the selected multimedia sever. If this occurs a second multimedia server will be selected by the main server using the same criteria used to select the first previously selected multimedia server. The main server will then send the specific data to the second multimedia server. Any subsequent requests for the specific data can then be redirected to either the first multimedia server of the second multimedia server. By redirecting at least some of the requests for the specific data to the second multimedia server, the load on the first multimedia server is lessened.

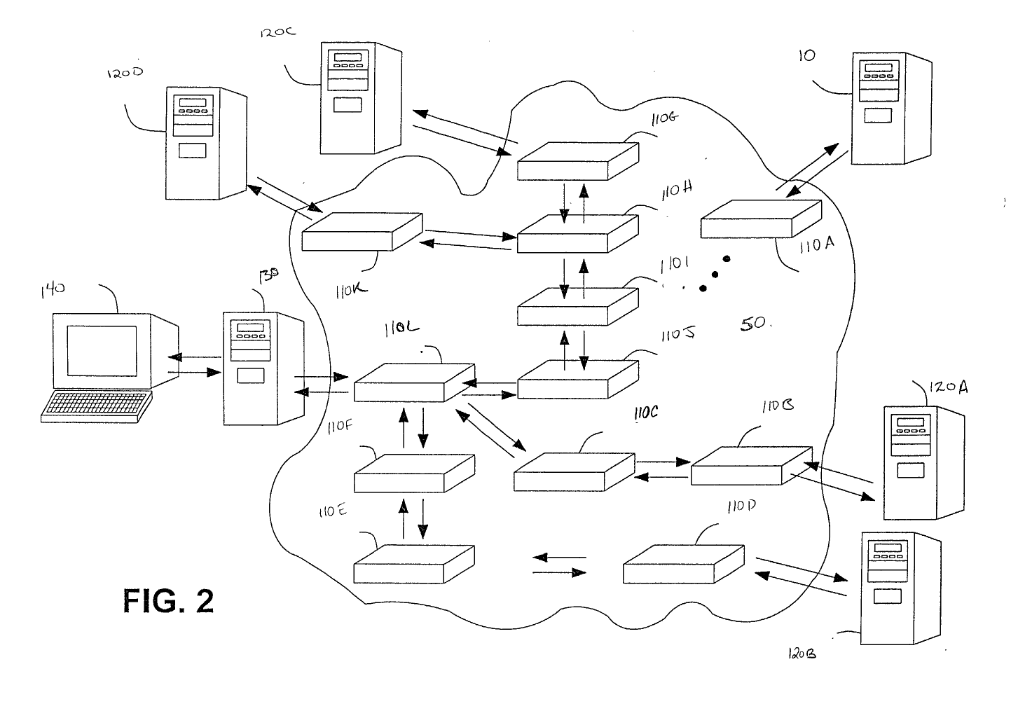

To determine where to position the multimedia content, the main storage and delivery server 10 may use any one of a number of criteria or the server 10 may use any combination of criteria from a given set of criteria. FIG. 2 will be used to illustrate some of these criteria.

In FIG. 2, the main server 10 is connected to a hub 110A. Hub 110A is considered part of the Internet 50 and is connected to other hubs and servers, as denoted by the dots. There are also four multimedia servers 120A, 120B, 120C, 120D shown. The server 120A is connected to hub 110B which is in turn connected to hub 110C. The server 120B is connected to hub 110D which is, in turn, connected to hub 110E. The hub 110E is connected to hub 110F. The server 120C is connected to hub 110G which is in turn connected to hub 110H. The hub 110H is connected to hub 110I which is, in turn, connected to hub 110J. The server 120D is connected to hub 110K. Hub 110K is connected to hub 110H. Hubs 110J, 110C and 110F are all connected to hub 110L. Hub 110L is connected to ISP hub server 130. The ISP hub server 130 is connected to an end user computer 140.

In order to determine a suitable position for multimedia content originally located at the main server 10, the main server 10 must determine the location of end users requesting the multimedia content. For example, the multimedia content may be requested by various end users connecting to the Internet 50 through the ISP hub server 130. As such, it would be desirable to position the multimedia content in close proximity to the ISP hub server 130. The ISP hub server 130 is located in Los Angeles, Calif. The geographical location of the servers are as follows:

| Server | Location |
|---|---|
| Main server 10 | New York, New York |
| Local server 120A | Houston, Texas |
| Local server 120B | Toronto, Ontario, |
| | CA |
| Local server 120C | Denver, Colorado |
| Local server 120D | San Jose, |
| | California |

Based on the geographic location of the ISP hub server 130, the main server 10 sends a copy of the multimedia content to either local server 120C or 120D. The main server 10 may send the multimedia to both local servers 120C and 120D if the number of end user requests is above a certain predetermined level. The positioning of the multimedia content at either the local server 120C or local server 120D would be as a result of the physical proximity of the local server to the ISP hub server 130. The positioning of the data according to the physical proximity of the ISP hub server 130 to a local server is preferably the main criterion for selecting a location to store a copy of the multimedia content.

Alternatively, the main server 10 may use logical distance, between the ISP hub server 130 and a local server, as opposed to physical distance as a possible criterion for determining which local server should store a copy of the multimedia content. If logical distance is defined as the number of hops (or hubs) between a local server and the ISP hub server 130, then the logical distance is shortest between the ISP hub server 130 (or an end user 10) and the local server 120A. A total of 3 hubs (hubs 110L, 110C, 110B) are between the ISP hub server 130 and the server 120A. This is in contrast to the 5 hubs (110K, 110H, 110I, 110J, 110L) between for server 120D and the ISP hub server 130. There are 5 hubs (110G, 110H, 110I, 110J, 100L) between the server 120C and the ISP hub server 130. There are 4 hubs (110D, 110E, 110F, 110L) between the server 110B and the ISP hub server 130. In this case, the main server 10 would position the multimedia content at the local server 120A.

Another possible criterion may be the quality of the connection between the ISP hub server 130 and each of the end user computers serviced by the ISP server 130. If the connections are mostly high speed ones, such as that provided by a digital subscriber line (DSL) connection, the multimedia content may positioned at a server which can store and transmit higher quality content. Otherwise, if the connections were relatively slow ones, such as 28.8 kbps modem connection, the multimedia content could be positioned at a server which provides lower quality content.

Also, the amount of data traffic per unit of time between a multimedia server and the ISP hub server may be another criterion. For example, the ISP hub server may have requested multimedia content from the main server 10. Based on the geographical location of the ISP hub server 130, the main server 10 sends a copy of the multimedia content to either local server 120C or 120D. However, the ISP hub server may have already requested a high volume of data from the local server 120C. As such, the volume of data traffic per unit of time between the ISP hub server and the local server 120D is optimal in that the multimedia content is readily available to the ISP hub server 130.

It should be noted that while the above scheme documents the ISP hub server as being instructed to retrieve multimedia content from specific multimedia servers this is not the only option. The main server 10 may also position multimedia content at the ISP hub server 130. As a result, the ISP hub server 130 would be able to provide multimedia content to not only its own end users but also to other ISP hub servers and, in turn, to end users connected to other ISP hub servers. The ISP hub server 130 may be an ideal choice if it is located closely to the majority of end users requesting the multimedia content, provided that the ISP hub server 130 has sufficient storage resources.

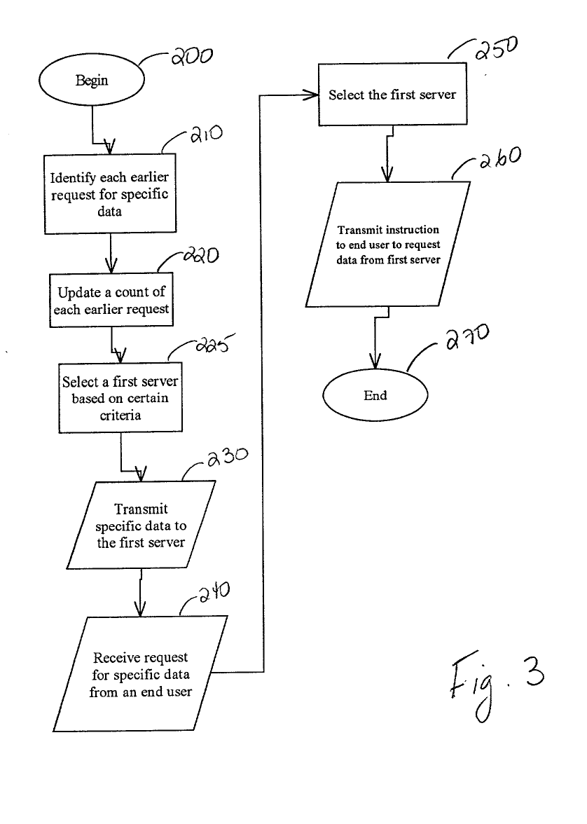

FIG. 3 is a flowchart illustrating the steps in a process for placing specific data, stored in a main server, at various multimedia servers. The process begins at step 200 and is followed by step 210 in which the main server identifies earlier requests received by the main server for some specific data, such as multimedia content. These requests are received from any number of end users that are able to connect to the main server through a network. The main server updates a count or cumulative total of the number of earlier requests received for that specific data in step 220. Based on certain criteria, including the number of requests received, the main server will select a first server in step 225. Upon selecting a first server, the main server will send the specific data to the first server in step 230. The criteria may include such factors as the geographical distance between the first server and any number of end users, the logical distance between the same first server and any number of end users, and economic constraints in terms of costs for storing data in that first server. In step 240, the main server receives a request for the specific data that was sent to the first server in step 230. In step 250, the main server selects the first server to send the specific data onto the end user requesting that specific data. Finally, the main server sends instructions to the end user to request anew the specific data from the first server, in step 260. The instructions may be in the form of an index file which points to the first server containing the specific data requested. The process then ends in step 270.

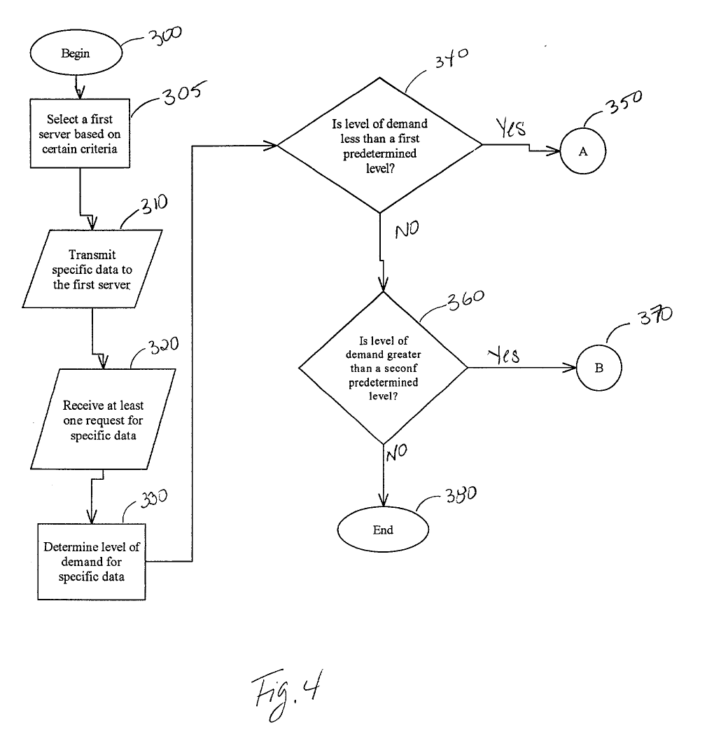

FIG. 4 is a flowchart illustrating the steps in a process for positioning and removing data in a data network. The process begins at step 300 and is followed by step 305 in which the main server selects a first server based on specific predetermined criteria. In step 310, the main server sends specific data to the first server. It is understood that the specific data may have multimedia content and that the first server is a multimedia server which stores multimedia content. Step 310 is similar to step 230 in FIG. 3. It is possible that steps 210 and 220 may also be implemented before step 310 in the process detailed in FIG. 4. In step 320, the main server receives at least one request for the specific data from various end users in the data network. That specific data is the same data sent to the first server in step 310. In step 330, the main server determines the level of demand for that specific data based on the number of end users requesting the data. The next step 340 determines if the level of demand is less than a first predetermined level. This predetermined level is the minimum level of demand for the specific data sent to the first server in order to justify its use of costly storage space. If the level of demand is less than the predetermined level then connector A 350 is followed. If not, then step 360 is followed. Step 360 determines whether the level of demand is greater than a second predetermined level. If the level of demand is greater than a second predetermined level, then the connector B 370 is followed. If not, then the process ends at step 380.

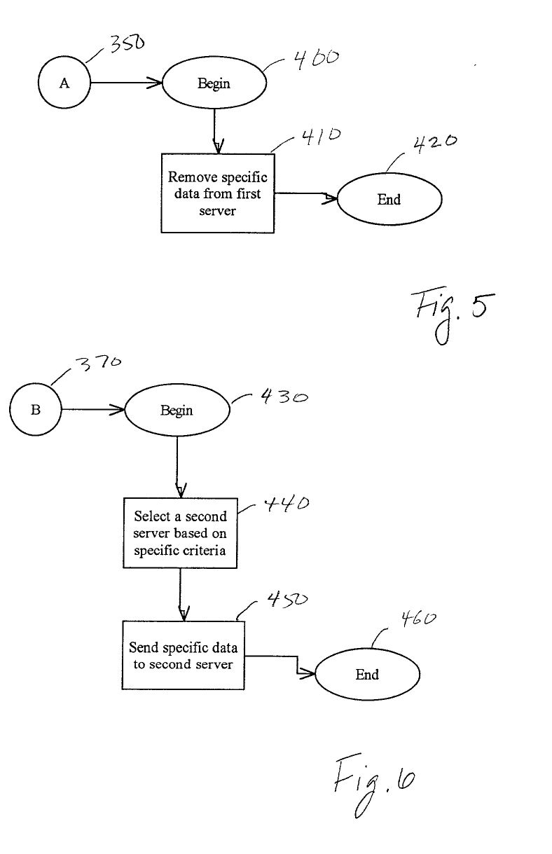

FIG. 5 is a subsidiary process which follows connector A 350 and begins at step 400. The subsidiary process involves removing specific data when the level of demands is less than a predetermined level. In step 410, the main server then removes the specific data from the first server, as a result of the decrease in the level of demand for that specific data. The removal step may entail sending instruction from the main server to the first server and the subsequent deletion by the first server of the specific data stored in the first server. The subsidiary process then ends at step 420. This may occur when, for instance, certain multimedia content is no longer popular among end-users in the data network. As a result, the level of demand, essentially the number of requests for that specific data, decreases.

FIG. 6 is another subsidiary process which follows connector B 370 and begins at step 430. This subsidiary process involves sending the specific data, previously sent to a first server, to a second server when the level of demand for that specific data is higher than a predetermined level. It follows that, the main server selects a second server to further position the specific data, in step 440. The selection is based on specific criteria such as geographical location of the second server. The next step 450 requires the main server to send the specific data to the second server. Following step 450, the sub-process ends at step 460.

It may also be conceivable that the present invention be embodied in a computer system, where the computer system serves as a data network management system for positioning for positioning throughout a data network. Also, the method for implementing the present invention may be embodied in a computer readable media. The computer-readable media would contain a set of instructions capable of implementing a method for positioning data at various servers according to the present invention.

What is claimed is:

1. A data network management system for positioning data in a data network of nodes, the data network having a plurality of data servers, and the data network having a plurality of end users, the system including:
a main data storage means for storing the data sent to the end users in the data network;
a data positioning means for sending a copy of data stored in the main data storage means to a first data server selected from the plurality of servers based on specific predetermined criteria, the first data server having a location proximate to at least one end user requesting the data from a node; and
a memory means for maintaining a data file containing a current location of the data sent to a first data server.

2. A system as defined in claim 1, wherein the data is multimedia content.

3. A system as defined in claim 1, wherein the location is geographically proximate to at least one end user.

4. A system as defined in claim 1, wherein the first data server is selected based on the following predetermined criteria chosen from the group consisting of:
number of networks hubs in a preferred path between the first data server and one end user;
speed of a link between the data network and one end user; and
amount of traffic along a preferred path between the first data server and one end user.

5. A system as defined in claim 4, wherein the first data server is a server which has multimedia files.

6. A method of positioning data in a data network, the data network having a main server and at least one data server, the data network having a plurality of end users, the method including the steps of:
(a) selecting a first data server from the at least one data server based on specific predetermined criteria;
(b) sending specific data from the main server to a first data server;
(c) receiving at the main server a first request for the specific data, the first request being sent by an end user to the main server;
(d) selecting the first data server as being suitable for providing the specific data requested by the end user; and
(e) sending instructions to the end user to request the specific data from the first data server.

7. A method as defined in claim 6, wherein the data is a server which has multimedia files.

8. A method as defined in claim 6, wherein the first data server is a server which has multimedia files.

9. A method of positioning multimedia data in a data network, the data network having a main server and at least one multimedia server, and the data network having a plurality of end users, the method including the steps of:
(a) identifying each earlier request for specific multimedia data by the plurality of end users and updating a count maintained of each earlier request by the plurality of end users;
(b) selecting a first multimedia server from the at least one multimedia server based on specific predetermined criteria;
(c) sending specific multimedia data from the main server to the first multimedia server, the specific multimedia data identified in at least one earlier request;
(d) receiving at the main server a first request for the specific multimedia data, the first request being sent by a first end user to the main server;
(e) selecting the first multimedia server as being suitable for providing the specific multimedia data requested by the first end user; and
(f) sending instructions to the first end user to request the specific multimedia data from the first data server.

10. A method as defined in claim 9, further including the step of updating a data file stored in the main server that the specific multimedia data is stored in the first multimedia server.

11. A method as defined in claim 9, wherein at least one of the specific predetermined criteria is chosen from the group consisting of:
geographical location of the first multimedia server relative to a geographical location of one of the plurality of end users requesting the specific multimedia data;
number of network hubs in a preferred path between the first multimedia server and one of the plurality of end users;
speed of a link between the data network and one of the plurality of end users; and
amount of data traffic between the first multimedia server and one of the plurality of end users.

12. A method as defined in claim 9, wherein the end user is one of a plurality of multimedia servers within the data network.

13. A method as defined in claim 9, wherein the at least one multimedia server is any data storage and delivery server.

14. A method as defined in claim 9, wherein the specific multimedia data sent to the first multimedia server is a data copy of the specific multimedia data stored in the main server.

15. A method as defined in claim 9, wherein the data network has a plurality of main servers, and each main server sends specific data to at least one multimedia server.

16. A method as defined in claim 9, wherein the end user requesting the data in step (c) is a server which has multimedia files.

17. A method of positioning data in a data network, the data network having a main server and at least one multimedia server, the data network having a plurality of end users, the method including the steps of:
(a) selecting a first data server from the at least one data server based on a set of specific predetermined criteria;
(b) sending specific data from the main server to a first data server;
(c) receiving at least one request for specific data from the plurality of end users;
(d) determining a level of demand for the specific data based on a number of requests from the plurality of end users for the specific data;
(e) if the level of demand for the specific data is less than a first predetermined level, removing the specific data from the first multimedia server;
(f) if the level of demand for the specific data is greater than a second predetermined level, executing the steps of:
(f1) selecting a second multimedia server based on at least a subset of specific predetermined criteria; and
(f2) sending a copy of the specific data to the second multimedia server.

18. A method as defined in claim 17, wherein at least one of the specific predetermined criteria is chosen from the group consisting of:
geographical location of the first multimedia server relative to a geographical location of one of the plurality of end users requesting the specific data;
number of network hubs in a preferred path between the first multimedia server and one of the plurality of end users;
speed of a link between the data network and one of the plurality of end users; and
amount of data traffic between the first multimedia server and one of the plurality of end users.

19. A method as defined in claim 17, wherein the specific data is multimedia content.

20. A method as defined in claim 17, wherein the second multimedia server is selected based on economic constraints.

21. A computer system serving as a data network management system for positioning data in a data network of nodes, the data network having a plurality of data servers, and the data network having a plurality of end users, the computer system including:
a main data storage means for storing the data sent to the end users in the data network;
a data positioning means for sending a copy of data stored in the main data storage means to a first data server selected from the plurality of servers based on specific predetermined criteria, the first data server having a location proximate to at least one end user requesting the data from a node; and
a memory means for maintaining a data file containing a current location of the data sent to a first data server.

22. A machine readable media containing computer readable and computer executable code to be executed by a data network, the data network having at least one data server, the data network having a plurality of end users, the code implementing a method including the steps of:
(a) selecting a first data server from the at least one data server based on specific predetermined criteria;
(b) sending specific data from the main server to a first data server;
(c) receiving at the main server a first request for the specific data, the first request being sent by an end user to the main server;
(d) selecting the first data server as being suitable for providing the specific data requested by the end user; and
(e) sending instructions to the end user to request the specific data from the first data server.
